(19) United States
(12) Patent Application Publication
(10) Pub. No.: US 2004/0031507 A1
(43) Pub. Date: Feb. 19, 2004

(54) Systems and method for automated cart washing

(75) Inventors: Joel Ross, Rancho Cunamanga, CA (US); Jerry Schabel, Colton, CA (US)

Correspondence Address: HOGAN & HARTSON L.L.P., 500 S. GRAND AVENUE, SUITE 1900, LOS ANGELES, CA, 90071-2611, US

(73) Assignee: Advanced Blending Corp.

(21) Appl. No.: 10/434,852

(22) Filed: May 9, 2003

Related U.S. Application Data
(60) Provisional application No. 60/379,905, filed on May 9, 2002.

(51) Int. Cl. B08B 3/00

(52) U.S. Cl. 134/123; 134/111

(57) ABSTRACT

A system and method for automated cart washing. There is therefore provided in a present embodiment of the invention an automated cart washer that includes a sump water source, a filter drawing filtered water from the sump, a pump supplying suction to draw the water through the filter, a bypass valve to divert wash water from a wash nozzle assembly, back to the sump when water flow through the wash nozzle assembly is not desired.

### CROSS-REFERENCE TO RELATED APPLICATIONS

This application claims the benefit of U.S. Provisional Patent Application No. 60/379,905, filed May 9, 2002, and U.S. Provisional Patent Application No. (attorney docket No. 89159.0003), filed Nov. 21, 2002, the contents of which are hereby incorporated by reference.

### BACKGROUND OF THE INVENTION

The present invention relates to a system and method of washing objects such as trash carts, produce bins, portable toilets and other receptacles or containers, and more particularly to a portable washing machine for cleaning these objects without having to transport them a great distance. These receptacles are typically too bulky for economically transporting them to and from a central cleaning location. In washing these objects a problem has typically arisen concerning disposal of the wash water. With increasing environmental awareness regarding water pollution, proper disposal of such waste water, that often contains noxious substances, creates an additional problem that must be addressed in cleaning these items.

Various solutions have been proposed for washing these items. One such solution is shipping the containers back to a warehouse facility where they are washed down and returned to the field. This process is typically costly due to transportation fuel costs, and labor costs from loading and unloading the containers, as well as manually washing them.

Conventional approaches have utilized washing the containers where they sit, and letting the wash water drain on to the ground or into the sewer system. In addition this approach needs access to a large volume of water.

Accordingly, there is a need for a way to wash containers economically in the field, and comply with environmental requirements by not discharging waste water in an unapproved manner.

### SUMMARY OF THE INVENTION

There is therefore provided in a present embodiment of the invention an automated cart washer that includes a sump water source, a filter drawing filtered water from the sump, a pump supplying suction to draw the water through the filter, a bypass valve to divert wash water from a wash nozzle assembly, back to the sump when water flow through the wash nozzle assembly is not desired.

### DESCRIPTION OF THE DRAWINGS

These and other features and advantages of the present invention will be better understood from the following detailed description read in light of the accompanying drawings, wherein:

FIG. 1 is a side view of a first embodiment of an automated cart washer (ACW);

FIG. 2 is a top view of a first embodiment of the automated cart washer;

FIG. 3 is an end view of a first embodiment of the automated cart washer;

FIG. 4 is a side view of a second embodiment of an automated cart washer having an alternative door arrangement;

FIG. 5 is a top view of a second embodiment of the automated cart washer having an alternative door arrangement;

FIG. 6 is a side view of a first embodiment of an automated cart washer (ACW) showing the placement of the refuse carts;

FIG. 7 is a top view of a first embodiment of the automated cart washer showing the placement of the refuse carts;

FIG. 8 is an end view of a first embodiment of the automated cart washer showing the placement of the refuse carts;

FIG. 9 is a schematic diagram of the electrical, pneumatic, and fluid flow;

FIG. 10 is a flow chart showing the process of cleaning carts;

FIG. 11 is a flow chart of a first embodiment of the timed wash cycle (1150 of FIG. 10);

FIG. 12 is a flow chart of a second embodiment of the timed wash cycle (1150 of FIG. 10);

FIG. 13 is a flow chart of a third embodiment of the timed wash cycle (1150 of FIG. 10);

FIG. 14 is a flow chart showing the steps in diverting the flow of the wash water when the spray cabinet door is opened; and

FIG. 15 is a block diagram showing the steps of performing periodic maintenance on the automatic cart washer.

Like reference numerals are used to designate like parts in the accompanying drawings.

### DETAILED DESCRIPTION

This application relates to a system and method of washing a variety of objects in the field. The apparatus as described may be used in a fixed location or configured for portable or mobile operation. For example, the machine may be mounted on a trailer or a truck bed or truck chasse for easy transport. The truck mounted version may be fixed to the truck bed or equipped with a detachable frame so that the machine may be lifted from the truck and sat down in a given location for a period of time until it needs to be moved to another location for use. The types of things that may be washed include refuse containers such as garbage cans with the hinged removal lids, produce crates which are typically loaded with vegetables in the field and used to transport fruits and vegetables to a warehouse location, and portable toilets. In fact, this apparatus method may be utilized to clean any large bulky item. It tends to be advantageous to use the machine when the cost of transporting such large bulky items to a central location for cleaning and then returning the items to the field tends to be prohibitive. By taking the washing machine to the containers, the cost of transporting to and from a central location is reduced.

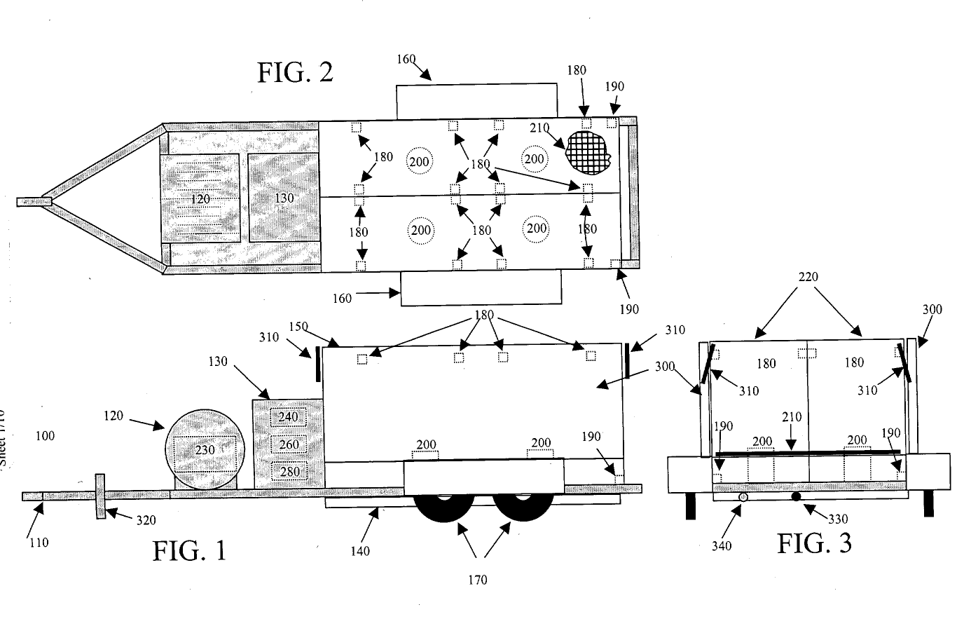

FIG. 1 is a side view of a mobile apparatus (automated cart washer or “ACW”) for washing objects including trash cans, produce bins, portable toilets and the like. The mobile apparatus includes a trailer chassis 110. The trailer chassis 110 is a conventionally constructed trailer chassis suitable for carrying the weight of the apparatus and any liquids used for cleaning the trash cans. Coupled to trailer chassis 110 is a sump tray or water holding tank 140. The sump tray is coupled to the spray cabinet so that a spray produced will drain back into the sump tray. The sump tray 140 is a pan-like structure that holds water or cleaning solution that is used in the washing process. Sump tray 140 is conventionally constructed from metal, fiberglass or equivalent materials and may include a series of baffles to prevent excess water movement or sloshing when the automated cart washer is in motion.

Coupled to the trailer frame 110 is a set of dual wheels and axels 170. Equivalently, a single axel may be used. The axels and wheels shown 170 are conventionally constructed. In an alternative embodiment one of the axels may be constructed utilizing methods known to those skilled in the art such that jack-knifing of the trailer tends to be is prevented. Fenders 160 cover the wheels 170 and are coupled to the trailer frame 110. In an embodiment the front axel 170 is a steerable axel that shifts axel camber. When the trailer assembly 110 is in tow and the tow vehicle is placed in reverse, an electrical solenoid (not shown) is activated. The solenoid activates a hydraulic cylinder that pivots the axel and shifts the axel camber in order to allow the axel to be steered in a reverse direction of the trailer.

The fenders 160 also provide a work surface to aid an operator in loading trashcans into the washing machine. The fenders may be constructed from metal or fiberglass or equivalent materials known to those skilled in the art. In an alternative embodiment, the fenders may be omitted.

A housing or spray cabinet for containing cleaning water or solution is coupled to the trailer frame 110 by methods known to those skilled in the art such that water or cleaning solution sprayed in the spray cabinet 150 drains into the water holding tank 140. Housing 150 is conventionally constructed from metal, fiberglass or equivalent material known to those skilled in the art. Housing 150 prevents wash water from escaping while the trashcans are being washed. An alternative embodiment of housing 150 spray heads may be mounted on the interior walls so the downward spray to clean the exterior of the trash cans is provided.

In the embodiment shown, housing 150 includes one or more doors 300 on each side of the housing that are parallel to the plane formed by the wheels 170. The doors 300 are configured in the exemplary embodiment so that they lift up to form a roof or sunshade over an operator standing by the side of the unit ACW and also allow free access to the inside of the unit so that two trashcans may be loaded on each side of the ACW without the doors interfering. The doors are coupled to the housing 150 by gas-loaded pistons that hold the doors. The doors 300 are hinged at the top of the unit.

Equivalently, other door arrangements may be provided by utilizing construction methods known to those skilled in the art. In short, other ways of providing quick access for loading and unloading trashcans, while also preventing the escape of wash water will equivalently work. For example, doors that open by folding out to the side may be utilized. Or, a curtain arrangement may be utilized. In a further equivalent embodiment, doors that are flexible and are track-mounted may be opened by pushing them to the side such that they fold back inside of the unit, toward the back of the unit.

A pump, motor and filter assembly 130 is coupled to the trailer frame 110 near the front of the housing 150 or any convenient location. Those skilled in the art will recognize the components that make up assembly 130 may be mounted at various locations about the trailer frame 110. The subassemblies of the pump, filter and motor assembly 130 may include a motor 280, a pump 260, and a filter 240. These components are coupled to the trailer chassis 110 using methods known to those skilled in the art. In the embodiment shown, motor 280 is a gasoline-powered engine. Equivalently, other types of motor, power plants, engines or the like may be substituted, for example AC or DC motors. Pump 260 is a conventionally constructed pump that is coupled to and driven by motor 280. Pump 260 is a conventionally constructed as known to those skilled in the art. Pump 260 selected such that it is able to handle a certain amount of solid or particulate material that may be present in the wastewater being circulated through it.

The pump 260 is typically selected to have a capability of pumping a 0.025-inch solid through the pump without damage to the pump. In an embodiment the water pump is powered by a direct drive 18-horse power gasoline motor.

A conventionally constructed filter assembly 240 is utilized to filter wastewater drawn from the sump tray 140 before it reaches pump 260. Filter 240 is coupled to trailer chassis 110 using methods known to those skilled in the art. Filter 240 is selected utilizing methods known to those skilled in the art to provide sufficient filtration such that spray nozzles, the pump and other components are not clogged. Also, filtration required will be influenced by requirements for gray or black water discharge. A bag filter assembly (not shown) is disposed in the sump tray 140. Bag filter 140 or its equivalents to filter, or pre-filter, large particle matter from wash water that has drained into the sump pan 140.

In an alternative embodiment, a water tank 120 is coupled to the trailer chassis 110. Water tank 120 is conventionally constructed from metal, plastic or other suitable materials. Water tank 120 is equipped with a baffle arrangement 230 constructed by methods known to those skilled in the art, so that excess water movement, or sloshing, during transport is minimized to improve the stability of the trailer.

The water tank 120 may be used to replenish the sump tray water level, supply a garden hose of wash water, supply a separate wash circuit, supply an auxiliary cleaning fluid, or be used for any other purpose, as will be appreciated by those skilled in the art.

Jack 320 is provided to prop up the trailer when it is parked. The jack 320 is coupled to the trailer frame 110 by appropriate hardware or fasteners. The jack typically may be set and adjusted with a locking pin, or equivalently, it may be hydraulic jacks or any other suitable type of support. In further alternative embodiments, the jack may be constructed by any method known to those skilled in art.

A start switch (now shown) coupled to activate a timer (not shown) is supplied at a convenient location so that an operator may initiate the washing operation, with an automatic cut-off at the end of the cycle. The start switch and the timer are conventionally constructed. Cut-off may be accomplished by bypassing water away from spray heads or assemblies while maintaining circulation, or in an alternative embodiment, by stopping the pump.

A spray cut-off switch 190 is coupled to the housing 150, or alternatively the trailer frame 110. The cut-off switch 190 is configured such that when the door 300 on either side of the trailer is opened, water flow is diverted from the spray heads 180, 200 so that water does not spray out, or escape from, the unit when the door is opened. The cut-off switch 190 is configured such that water is diverted from the spray assemblies 180, 200 but remains circulating through the pump. By maintaining water circulation, start-up time of the next wash cycle is minimized when resumption of operation is desired, after the interruption. Also, by continuously operating the motor, pump, and filter assembly, its life is maximized due to reduced start and stop cycling. In an embodiment, the sump tray 140 includes a float switch such that if the water level in the sump tray falls below the in level to the pump 260, the motor is cut off. This prevents the motor from being starved for water and subsequently burning out.

The wash water path in the ACW unit is constructed such that water from the sump 140 is routed through the pump assembly to the spray head assemblies 180, 200. After spraying the cart down, the wash water drains back into the water holding tank or sump 140. The wash water may typically contain a non-solvent based soap compound formulated to provide low sudsing cleaning, while preserving the neoprene pump and motor seals. The water that is sprayed through nozzles 180 and 200 drains into the sump pan 140 where it is collected. A bag filter (not shown) filters the large particulate matter from the sump water. The pump is chosen to operate with a certain amount of debris in the water. In an embodiment, the sump filter is a strainer filter, bag filter or equivalent designed to filter particles larger than 100 microns. The water in the sump is also drawn through a second filter 240 to remove particulate matter. Water from filter 240 is passed through a recirculating pump 260 driven by motor 280 and circulated through the spray heads 180 and 200.

In this embodiment, water may be drawn from either, or both of the water tank 120 or the sump 140. In addition, a dump or relief valve with a solenoid control is provided at the output of the second recirculating pump 260 so that when the water has become fouled beyond usage it may be dumped in an appropriate location.

The spray nozzles are typically selected so that a 0.025 inch solid will not damage or clog them. In an embodiment, the spray nozzle 200 for cleaning the interior of the container is a single spray jet.

In an alternative embodiment sixteen spray heads 180 are utilized to clean the outside of the containers. In an embodiment, the spray heads are configured so that they may be adjusted to any degree or spray pattern needed to wash the exterior surfaces of the container. The spray heads 180 are of a clip-on design that allows the nozzle to be cleaned outside of the machine. The nozzles may be cleaned in an embodiment by removing them from the clip, cleaning them and then replacing them. In a further alternative embodiment, the spray nozzles 180 are clip-mounted through holes in the cover 150. In this manner, if a nozzle becomes clogged, it may be removed for cleaning from the exterior side of the cover 150.

In an embodiment the wash nozzle assembly 200 rotates in a circular manner in order to cover the entire inner surface of the item or cart being washed. Alternatively, one or more fixed nozzles may be used having a resulting pattern that is sufficient to cover the interior cart with wash water. A typical fixed wash nozzle 200 tends to emit 26 gallons of wash solution per minute.

In an embodiment of the invention, the enclosure 150 utilizes an epoxy-coated interior, and may include a center divider to subdivide the spray cabinet.

FIG. 2 is a top view of a first embodiment of the automated cart washer. This view shows a cut-out in the spray housing or cabinet 150 at 210. The cut-out shows the detail of the debris tray that the carts rest on top of. The debris tray allows water to drain through to the water holding tank 140. In the embodiment shown, the spray nozzles 180, 200 are shown substantially mounted flush with the debris tray to aid in loading and unloading the carts.

FIG. 3 is an end view of the first embodiment of automated cart washer. This view shows a water nozzle connection for a garden hose disposed at the back, and the location of the dump valve. The end view also shows the location of a center divider that may be utilized in an embodiment to separate the right and left halves of the ACW into two independent units.

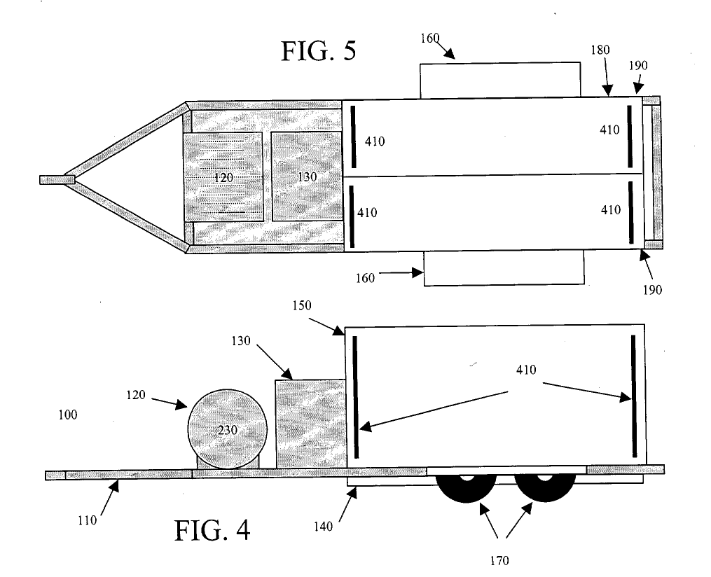

FIG. 4 is a side view of a second embodiment of an automated cart washer having an alternative door arrangement. In this arrangement, the doors are doors 410 are shown folding inside the unit when the carts are loaded and unloaded. Hinging method known by those skilled in the art is appropriately used to make the doors cantilever in and out of the unit.

FIG. 5 is a top view of the second embodiment of the automated cart washer having an alternative door arrangement. This is a top view of the embodiment of FIG. 4 showing the position of the doors in each half of the ACW.

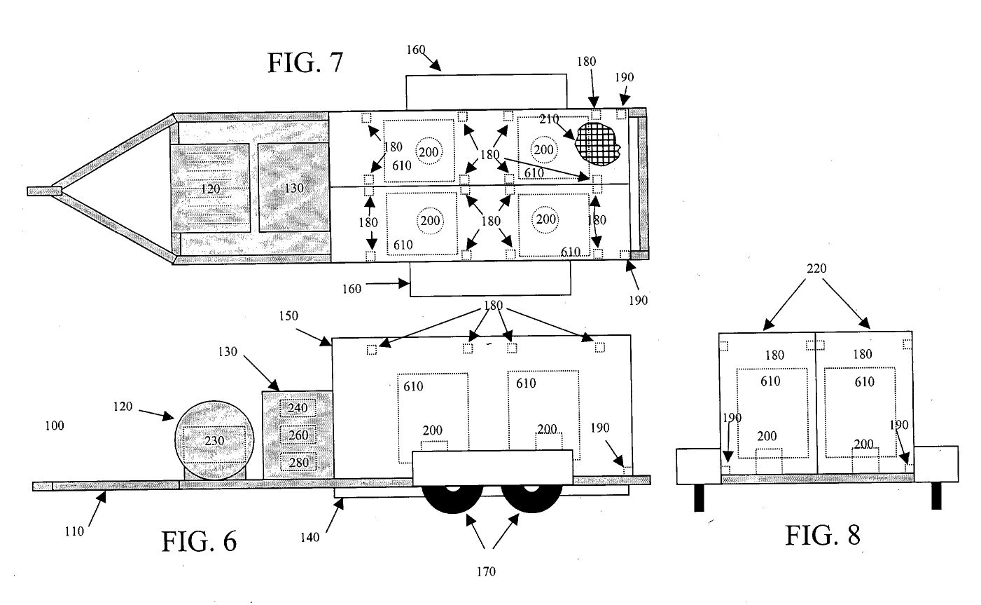

FIG. 6 is a side view of a first embodiment of an automated cart washer (ACW) showing the placement of the refuse carts. Two doors 300 are located on either side of the machine. The doors open in an upward manner and are supported by gas-loaded struts or their equivalent to hold the doors in the upward position. With the doors in an open position, four carts 610 may be placed upside down in the washer. Two carts are placed in each side with the lids of each cart facing one another. By placing the carts with the lids facing each other, the lids support each other so that the outsides of the cart may be washed. Alternatively, a bracket or its equivalent may be supplied to prop the lids up as required so that they do not interfere with the flow of spray onto the surface of each cart. The carts are loaded and unloaded at a level of approximately 32 inches from the ground. A 32-inch height tends to help ease the loading and unloading process. However, any convenient height may be used depending upon the size of the item being washed in the automated cart washing machine.

The washing machine is a self-contained unit utilizing a closed-loop spray system. In the embodiment shown, the wash water is loaded in the sump pan 140. Wash water may initially be supplied from and replenished from a water tank 120 that is provided on the ACW machine chassis 110. However, the machine may be adapted for use with an external water tank, especially when the machine is used in a remote location for an extended period of time.

In an alternative embodiment, a second supply tank (not shown) and spray circuit is provided to deliver a chemical pretreatment solution that tends to lift off painted graffiti placed on the outside of refuse containers being washed. Alternatively, a single loop system may be used if equipped with a series of valves to switch in different chemical solutions to the spray nozzles sequentially or, the pre-treat may be mixed in the wash water, as an additive. Equivalently, other methods known by those skilled in the art may be used to deliver one or more chemical solutions or washing solutions spray cabinet.

One or more operators may wash the carts utilizing this machine. One operator may work on one side of the machine loading two carts at a time and unloading them as they are completed. Likewise, on the other side of the machine, the second operator may do the same. In such an arrangement, it is advantageous to utilize a center divider that separates the two wash nozzles on one side of the chamber 150 from the second set of nozzles on the other side of the enclosure 150. That way the two operators may work independently without one interrupting the other's wash cycle by opening the doors. Such an arrangement would, by necessity, include two bypass switches 190 and two closed-loop circulation paths so that when one side of the washer is open the wash water is diverted through the closed path away from the two nozzles without interrupting the wash cycle being implemented on the far side of the cart. Such an embodiment of an automated cart washer that allows two operators to use it would, of course, also include two sets of timer controls and wash cycle start switches.

Those skilled in the art will realize that a two operated embodiment of the automated cart washer may utilize a single or dual bypass path for the wash water when one or both of the doors are opened. For example, a single bypass path for wash water may be supplied so that when both doors are open the wash water is diverted fully through the bypass path. In an alternative embodiment when only one of the doors is open, the wash water from the side with the one door open is diverted through the bypass path. Alternatively, when one side of the washing machine is opened the operation may be structure so that instead of the water passing through the bypass path, it is simply diverted through the spray nozzles on the opposite side of the automated cart washer that are being washed.

In a further alternative embodiment for a two-person operation, two completely separate circuits may be provided each having a separate bypass closed loop and separate wash water paths.

FIG. 7 is a top view of a first embodiment of the automated cart washer showing the placement of the refuse carts.

FIG. 8 is an end view of a first embodiment of the automated cart washer showing the placement of the refuse carts.

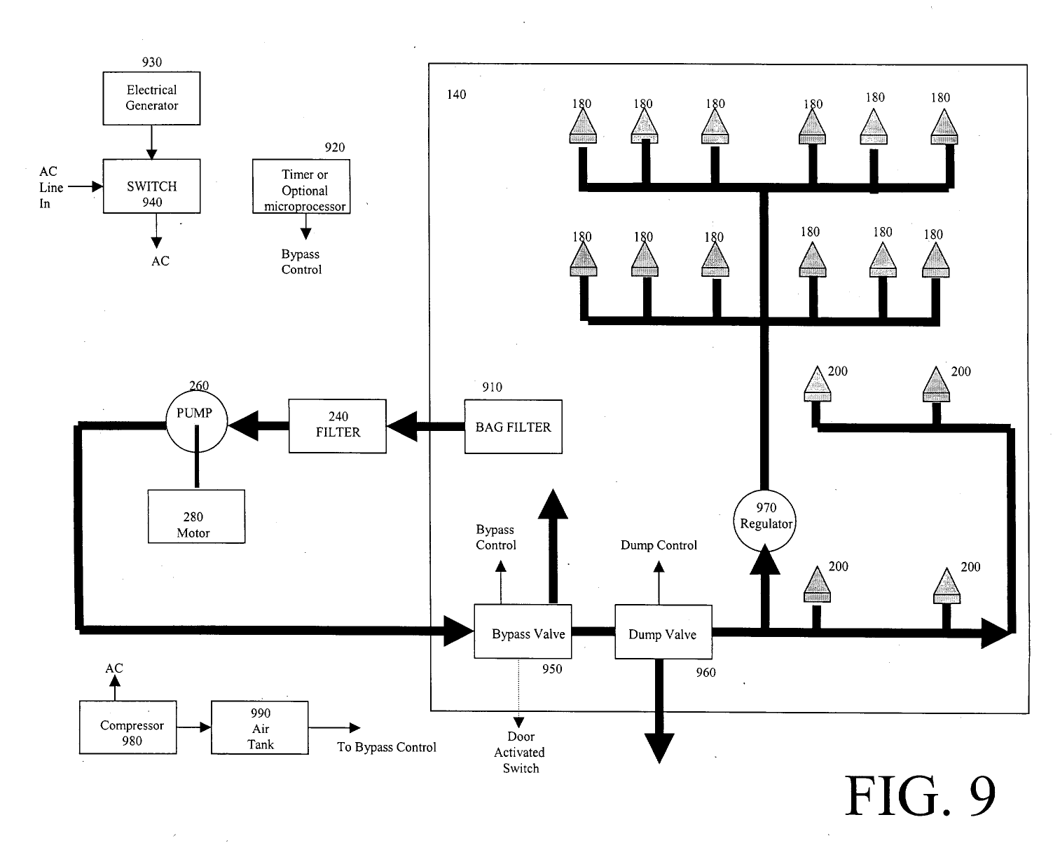

FIG. 9 is a schematic diagram of the electrical, pneumatic, and fluid flow in the ACW. In the embodiment shown, the sump pan 140 acts as a reservoir to complete the wash water or fluid circuit that recirculates the wash water. Bag filter 910 draws water though it and into the input of filter 240 which in turn supplies water or wash fluid to pump 260. Pump 260 supplies as determined by methods known to those skilled in the art, sufficient suction to draw the fluid of wash water through the bag filter 910 and filter 240 such that a sufficient flow in gallons per minute is maintained.

Pump 260 is driven by a motor 280. In the embodiment shown, motor 280 uses a direct drive shaft to drive pump 260. However, in an alternative embodiment, equivalent methods of driving or coupling the motor to the pump known to those skilled in the art may be utilized. In the embodiment shown, motor 280 is a gasoline engine. In equivalent embodiments an electrical motor or other type of drive source to turn the pump may be substituted.

The filtered wash water output of pump 260 is routed to a bypass valve 950 that has a first output that dumps the fluid back into the sump pan 140. When the bypass valve dumps fluid back into the pan the flow of wash water is maintained and the pump continues running without being forced to run dry. By maintaining circulation, starting and stopping of the pump and motor is minimized, tending to increase the life of the pump and motor.

Bypass valve 950 is actuated to a second output by a door activated switch. When the doors are opened the bypass valve switches to the first output so that the wash fluid flows into the sump 140 as previously described. When the door is closed wash water is routed to the second output that is coupled to the input of a dump valve 960. The normally closed position of dump valve 960 routes the wash water to two sets of spray head assemblies 200 and 180. When the dump valve is actuated, the dump valve routes it's input to an external connection leading to a disposal site, such as a sewer line, cesspool or clarifier to suitably dispose of water from the sump 140. Dump valve 960 has a control input “dump control line” that may utilize manual, pneumatic, or electrical control, or their equivalent, to actuate the dump valve. Actuation would typically be initiated by an operator when he desires to change the water. Dump valve 960 is conventionally constructed as known to those skilled in the art. Bypass valve 950 has a control input “bypass control line” that may be actuated by manual, electrical, pneumatic, or equivalent methods known to those skilled in the art. Bypass valve 950 is conventionally constructed as known to those skilled in the art. In addition, the bypass valve 950 is shown to have a door activated switch control input. The door activated switch in equivalent embodiments may be identical to the bypass control or coupled to it in parallel as known to those skilled in the art so that either control input activates the valve.

The second output of the dump valve 960 routed to spray head assemblies 180 and 200 flows through the first branch of a “Y” junction to spray head assemblies 180 through a pressure regulator 970. Pressure regulator 970 is selected by methods known to those skilled in the art to supply a satisfactory flow rate to the plurality of spray head assemblies 180 that are typically utilized to clean the exterior of the container sitting above the sump pan 140. Wash water emanating from spray heads 180 and falling on the carts drips back into the sump pan 140 to complete the wash water circuit.

The second branch of the “Y” routes wash water to a plurality of spray head assemblies 200. Spray head assemblies 200 receive water at the full pressure output from pump 260. In alternative embodiments, a pressure regulator (not shown) may be inserted in this branch to regulate pressure to a desired value for a given application by means known to those skilled in the art.

In the embodiment shown, four spray head assemblies 200 are shown. The spray head assemblies 200 are disposed beneath the waste receptacle in order to thoroughly wash the inside of it. Water from spray assemblies 200 drips back into the sump 140 completing the wash water circuit.

Spray head assemblies 200 may be formed in various configurations to meet the needs of washing a given type of container. For example, a single spray nozzle (or jet) may make up each spray assembly 200, or equivalently, a plurality of individual spray jets may be disposed in spray head assembly 200. In a further alternative embodiment, spray assembly 200 is configured to rotate or pulsate in order to distribute water on the interior surface of the cart or receptacle being washed. Likewise, spray head assemblies 180 may include a plurality of single spray nozzles, or a single spray nozzle, that rotates or is fixed.

The controls for the various valves, switches, and timers may be run from AC line current, a battery system (such as a 12 volt car battery) or a pneumatic system. Any suitable control method known to those skilled in the art to control the timing of the wash cycle and the application of wash water appropriate valves may be utilized. In the embodiment shown, the bypass control to the bypass valve 950 is actuated pneumatically. A compressor 980 powered by an AC power source outputs air into an air tank or reservoir 990. Regulated air output from the air tank is supplied to the bypass control valve 950 in order to activate the door switch. Electrical power to the ACW may be supplied by an AC line in, or by an electrical generator 930. Electrical generator 930 may either be mounted on the ACW or located nearby. The generator output and power from the AC line input are routed to a switch 940 so that the user may select the power source via a switch 940.

The timer 920 is coupled to the bypass control line shuts spray off going to the nozzles when the wash cycle ends. Timer 920 is a conventionally constructed mechanical timer. In alternative embodiments, the timer 920 may be implemented by a microprocessor or other integrated circuit timer. In addition, an alarm light or other indication may be supplied in order to signal the operator that the wash cycle has been completed.

In further alternative embodiments, two wash water paths may be provided utilizing methods known to those skilled in the art so that two operators on each side of the ACW may work independently. In such an embodiment, the number of spray heads would be evenly divided between the two hydraulic circuits and an additional bypass valve and timer would be supplied for the second wash water.

The closed loop fluid flow system filters 240, 910 the cycled wash water without disposing of it on the ground. Thus, gray or black water, depending on what is being washed, is filtered and reused for washing multiple items until the water becomes so foul it is no longer practical to filter it. At that time the dump valve 960 is engaged and the waste wash water is dumped in an appropriate septic system or sewer system depending upon the quality of the water being dumped, and whether or not it is gray water or black water.

Chemical solutions or soaps may be introduced to the wash water in order to clean the containers more thoroughly or to remove things such as graffiti from the exterior surfaces being washed. Typically a non-solvent based soap or washing solution tends to optimize pump life since the non-solvent based cleaning solution tends not to dissolve the neoprene pump seals.

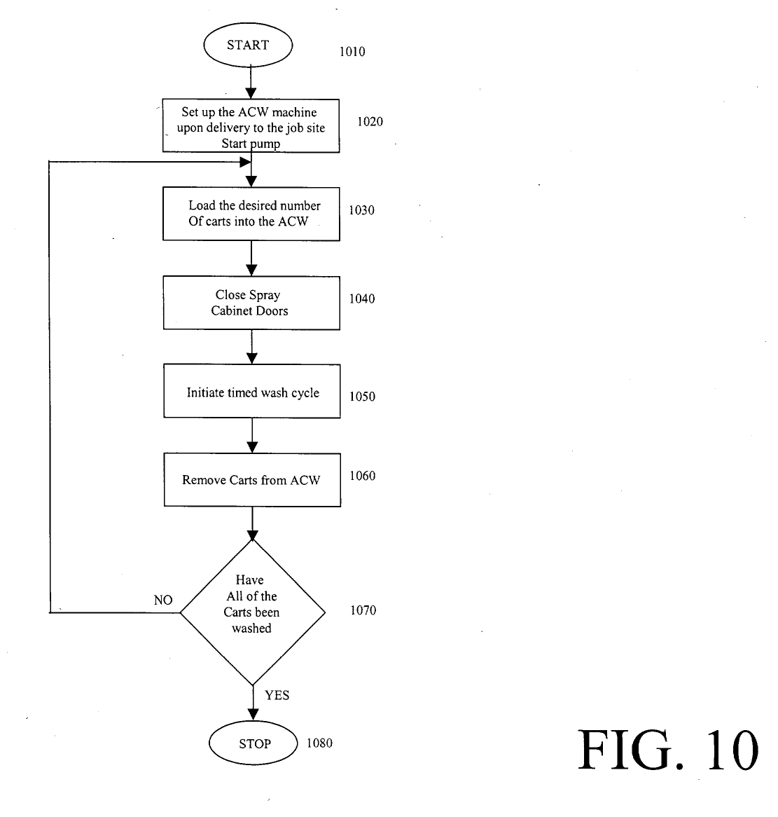

FIG. 10 is a flow chart showing the process of cleaning carts. A set-up procedure includes the steps of unloading the cart or setting it up at the desired location and preparing the desired wash solutions. The next step would be to provide sufficient water to the drain pan to prime the pump that draws water from the drain pan. Once the drain pan is filled, an operator starts the pump motor so that water begins to circulate if the doors are closed, such as during a wash cycle, the water circulates through the wash nozzles and back into the tray, where it is again pumped through the nozzles. When the door is open, the water flow is switched away from the nozzles and through a pipe such that the wash nozzles are bypassed and a flow of cleaning solution is maintained.

The process for washing a cart or item includes the steps of setting up the machine at a remote location, opening one or more doors of the automated cart washer, placing one or more carts over the wash nozzles that are located within the cart. The operator initiates a wash cycle by pressing a button or actuating a lever or other actuation device to engage a timer and series of control valves that initiate a timed wash cycle. The timer may be a mechanical or electrical device or its equivalent that provides one or more washing cycles.

A typical wash cycle lasts from one and a half to three minutes. After the operator initiates a wash sequence, the cart is washed by spray water emanating from the nozzle located underneath the cart. The sequence of operation may include a step of causing the wash nozzles to rotate in a circular manner, if a circulating wash nozzle is used. The wash cycle that is initiated may include one or more steps as desired for a particular application. For example, for washing trashcans the wash cycle may include an exterior pre-treat cycle where a solvent is sprayed on the exterior of the carts. The exterior pre-treat sequence may be followed by the interior wash sequence. The cart wash cycle may include the steps of first washing the cart exterior and next washing the cart interior, or vice versa. An alternate embodiment of the wash cycle may include simultaneous applying both the exterior and interior washing cycles. Those skilled in the art will realize that the choice of sequential exterior and interior washing cycles versus concurrent exterior and interior washing cycles will depend upon the application and the equipment available for a given implementation or embodiment of the cart washer. For example, in a automated cart washer in which a high through-put is desired, it may be desirable to utilize components with sufficient capacity to provide wash water to the interior and the exterior of the cart simultaneously. In an alternative embodiment in which a slower through-put is possible, it may be desirable to utilize components having a lower pumping capacity and sequentially wash the exterior and interior.

When the automated cart washer finishes the wash cycle the operator opens the side doors and removes the cleaned containers. The process then may be repeated indefinitely until all the carts or other items needing washing are finished. The wash cycle may be interrupted at any time by the operator opening the door.

FIG. 10 is a flow chart showing the process of cleaning carts. At step 1010 the process is started. At the next step 1020 the automatic cart washing machine is set-up upon delivery to the job site, and the pump is started in order to keep wash water circulating throughout the ACW. Next, an operator loads the desired number of carts into the automated cart washer at step 1030. Next, at step 1040, the operator closes the spray cabinet doors, which deactivates the bypass valve. At the next 1050 the operator initiates a timed wash cycle in which water from the sump pan is routed to the spray heads for a timed wash cycle. Next at step 1060 after completion of washing, the bypass valve is engaged diverting water away from the spray heads. At step 1060 when the operator opens the doors and removes the carts from the ACW machine the bypass switch on the spray cabinet doors is also engaged enabling the bypass path.

At step 1070 a decision is made as to whether all the carts have been washed. If all the carts to be washed are finished, then the entire process stops at step 1080. If more carts remain to be washed, the process routes back from step 1070 to the input of step 1030 and the operator loads a new set of carts into the ACW and the process repeats.

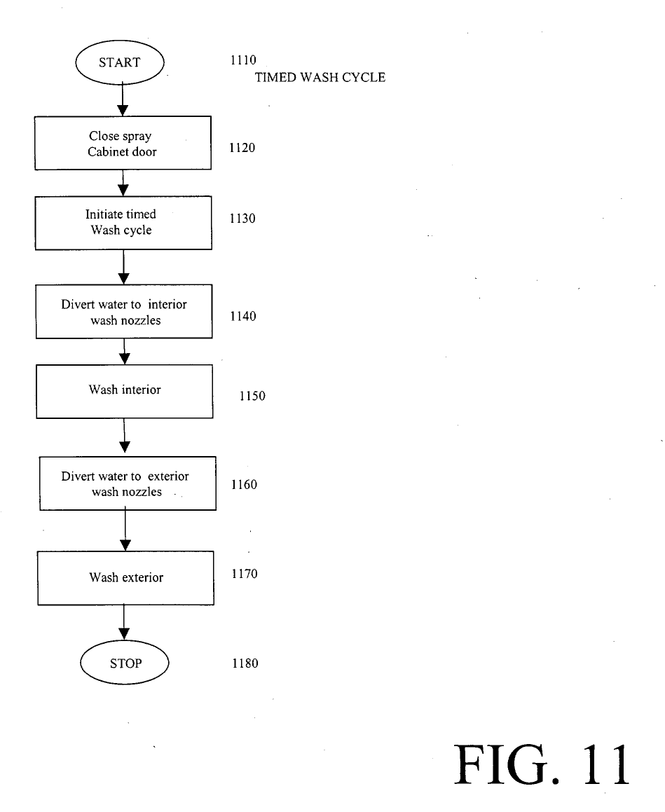

FIG. 11 is a flow chart of a first embodiment of the timed wash cycle shown as step 1050 in FIG. 10. In this embodiment of the timed wash cycle the wash cycle starts at step 1110 the step 1120 an operator closes the spray cabinet door. At step 1130 the operator initiates the timed wash cycle. At step 1140 water is diverted to the interior wash nozzle so that the interior of the cans or trash receptacles are washed. At step 1150 the timed wash of the interior of the cans takes place. At step 1160 the water supply is diverted to the exterior wash nozzles. And at step 1170 the diverted water washes the exterior of the cans. Then, when the time for washing the exterior has been expended, the process stops at step 1180.

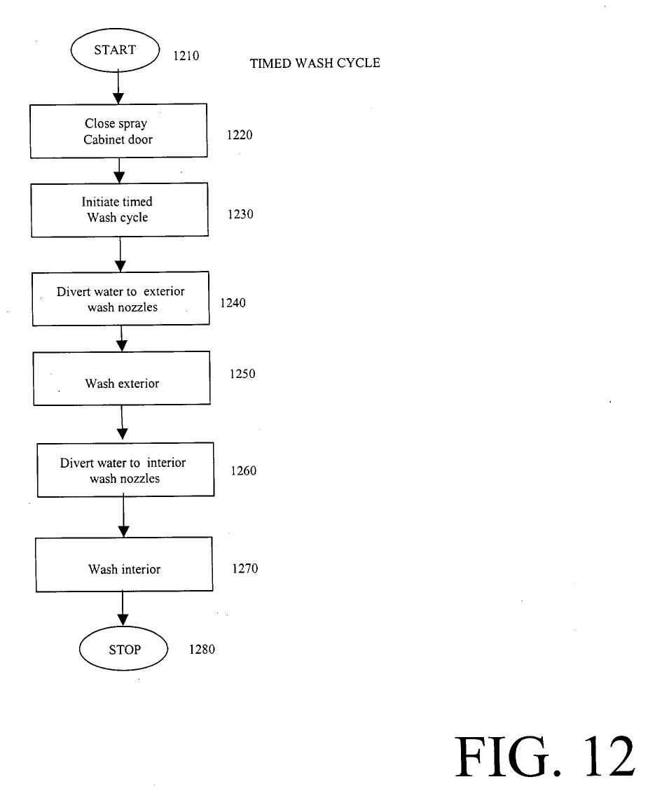

FIG. 12 is a flow chart of a second embodiment of the timed wash cycle 1050 of FIG. 10. At step 1210 the timed wash cycle begins. At step 1220 the operator closes the spray cabinet door. At step 1230 the operator initiates the timed wash cycle. At step 1240 water is diverted to the exterior wash nozzles. At step 1250 the exterior of the receptacle is washed. At step 1260 water is diverted to the interior wash nozzles. At step 1270 the interior of the receptacle is washed. At step 1280 the process stops at the end of the set time.

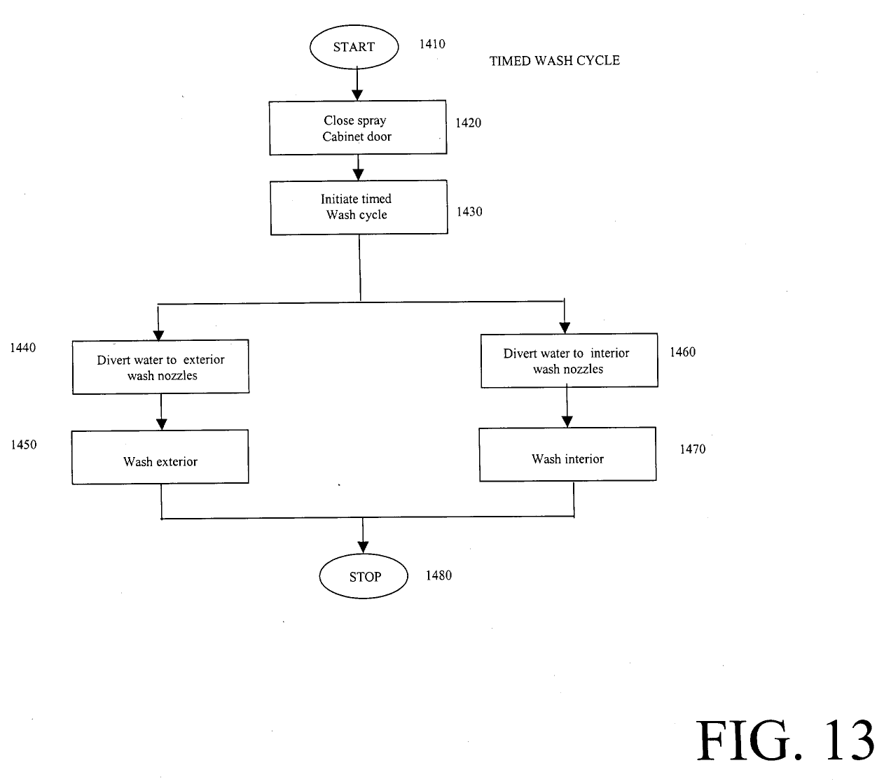

FIG. 13 is flow chart of a third embodiment of the timed wash cycle, step 1050 of FIG. 10. At step 1410 the time wash cycle begins. At step 1420 the operator closes the spray cabinet door. At step 1430 the timed wash cycle is initiated. Next, two processes are initiated in parallel. At step 1440 water is diverted to the exterior wash nozzles, and simultaneously at step 1460 water is diverted to the interior wash nozzles. Next, the exteriors and the interiors are washed at steps 1450 and 1470 respectively. Those skilled in the art will appreciate the exterior and interior wash cycles may be of the same or different time depending on the amount of cleaning desired. At step 1480 the process stops.

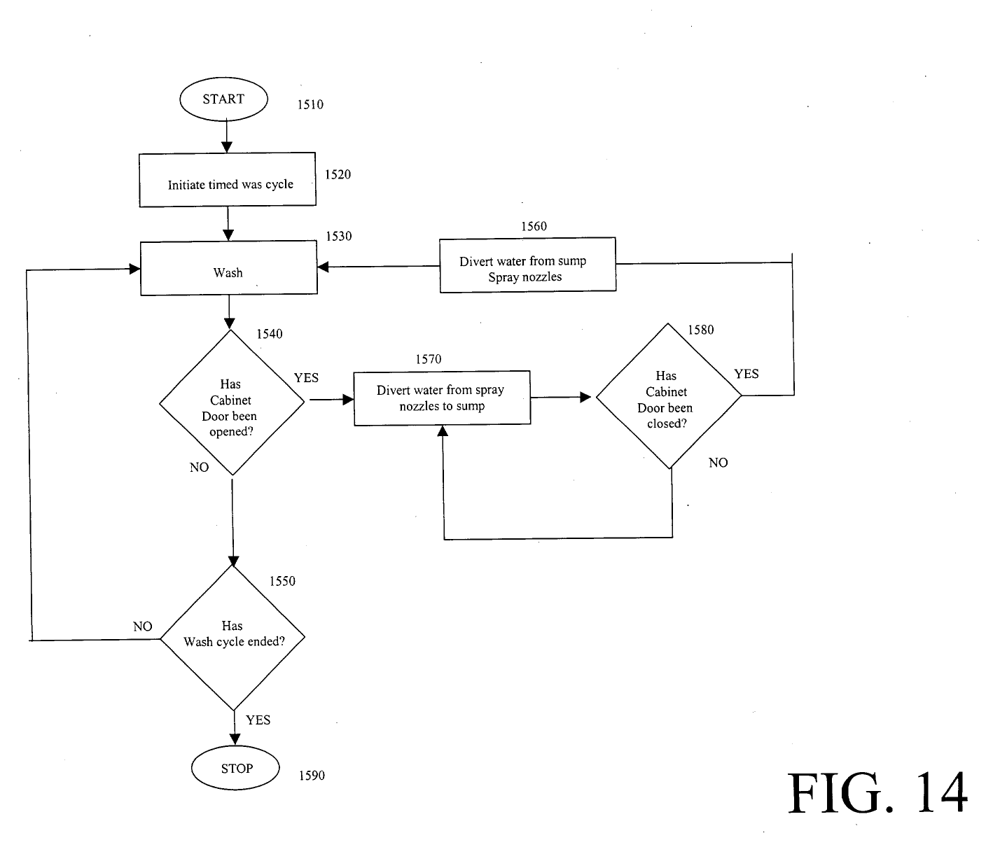

FIG. 14 is a flow chart showing the steps in diverting the flow of the wash water when the spray cabinet door is opened. At step 1510 the process is initiated. At step 1520 a timed wash cycle is initiated. At step 1530 the wash cycle starts. At step 1540, a decision block asking if the cabinet door has been opened, is evaluated by looking at the switch in the cabinet door. At 1540 if the cabinet door has been found to be opened by the switch reading, the process passes to step 1570 where water is diverted away from the spray nozzles directly into the sump. Next, a decision block at 1580 is evaluated to see if the cabinet door has been closed. If the cabinet door has not been closed, the water continues to be diverted at block 1570. If at block 1580 the cabinet doors have been found to be closed, by reading the switch position, then at block 1560 water from the sump is again diverted back to the spray nozzles and the wash cycle at block 1530 continues.

Returning to block 1540, if it is found that the cabinet door has not been opened, control passes to block 1550 where a decision is made whether or not the wash cycle has been ended by evaluating the timer output. If the wash cycle has not ended, control passes back to block 1530 where the cart continues to be washed and monitored to see if the door has been opened. Returning to block 1550, if the wash cycle has ended, the process stops at block 1590.

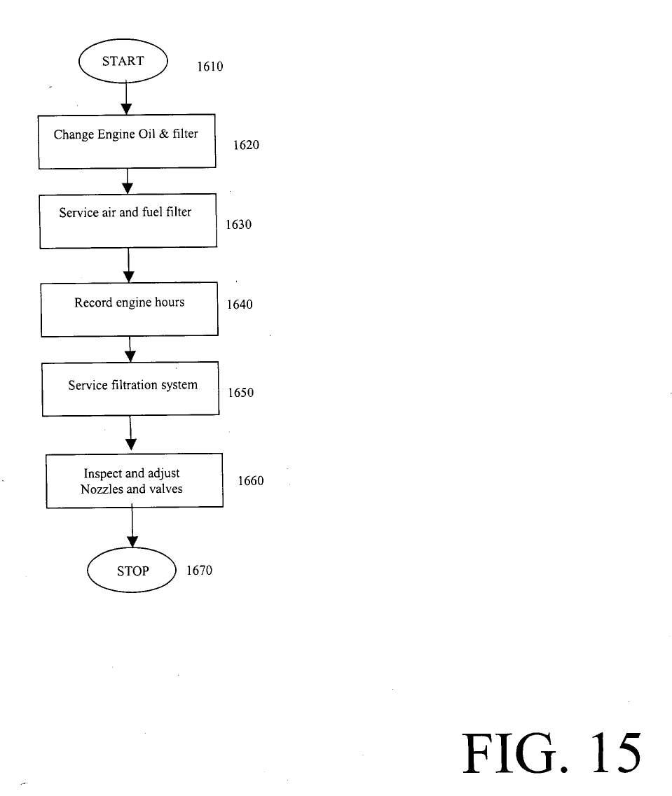

FIG. 15 is a block diagram showing the steps of performing periodic maintenance on the automatic cart washer. At the start of the maintenance interval at step 1610 the engine and oil filter are changed at step 1620, at step 1630 the air and fuel filter are serviced, at step 1640 the engine hours are recorded. At step 1650 the filtration system is serviced, including checking clogging of the filter, and possibly replacing the bag on the bag filter. At step 1660 the maintenance technician inspects and adjusts the nozzles and valves as necessary. At step 1670 the process stops. Those skilled in the art will, of course, realize that these steps may be performed in any order and those presented are exemplary. Also, those skilled in the art will realize that the time between maintenance intervals will be adjusted according to the conditions under which the unit is operated.

In an embodiment of the automated cart washer, the enclosure 150 is equipped with a series of adjustable racks that are four feet by four feet square and mounted on fixed track that allow the racks to be removed. Such an arrangement of removable racks would typically allow containers ranging from two inches to seventy-two inches high to be placed on the rack. When placed on the rack, a flexible wash nozzle is then positioned under the container with another placed on top of the container. The wash nozzles would typically be coupled through a quick disconnect fitting to a pipe running vertically within the outer wall of the enclosure 150.

A typical chemical solution utilized in the automated cart washer is South Coast Air Quality Air Management District (SCAQMD) certified as a non-solvent based cleaner.

1. An automated cart washer including:
a sump water source,
a filter drawing filtered water from the sump,
a pump supplying suction to draw the water through the filter,
a bypass valve to divert wash water from a wash nozzle assembly, back to the sump when water flow through the wash nozzle assembly is not desired.
